(19) United States
(12) Patent Application Publication
(10) Pub. No.: US 2022/0369425 A1
(43) Pub. Date: Nov. 17, 2022

(54) CERAMIC HEATER AND METHOD OF MANUFACTURING THE CERAMIC HEATER

(71) Applicant: NGK Insulators, Ltd., Nagoya-City (JP)

(72) Inventors: Takayoshi AKAO, Kasugai-City (JP); Natsuki HIRATA, Nagoya-City (JP)

(73) Assignee: NGK Insulators, Ltd., Nagoya-City (JP)

(21) Appl. No.: 17/816,022

(22) Filed: Jul. 29, 2022

Related U.S. Application Data
(63) Continuation of application No. PCT/JP2021/006588, filed on Feb. 22, 2021.

(30) Foreign Application Priority Data
Feb. 26, 2020 (JP) 2020-030724

(51) Int. Cl. H05B 3/14; H05B 3/26; H05B 3/74

(52) U.S. Cl. CPC H05B 3/141; H05B 3/265; H05B 3/748

(57) ABSTRACT

A method of manufacturing a ceramic heater, the method includes the steps of: (a) forming, on a surface of a first ceramic fired layer or an unfired layer, a resistance heating element or its precursor in a predetermined pattern; (b) forming a recessed groove along a longitudinal direction by radiating laser light to the resistance heating element or its precursor; (c) obtaining a layered body by disposing a second ceramic unfired layer on the surface of the first ceramic fired layer or the unfired layer; and (d) obtaining the ceramic heater in which the resistance heating element is embedded in a ceramic substrate by performing hot press firing on the layered body, wherein, in the step (b), the recessed groove is formed such that a side wall surface of the recessed groove is inclined relative to the surface of the first ceramic fired layer or the unfired layer.

### BACKGROUND OF THE INVENTION

### 1. Field of the Invention

The present invention relates to a ceramic heater and a method of manufacturing the ceramic heater.

### 2. Description of the Related Art

Hitherto, a ceramic heater used for a semiconductor manufacturing apparatus is known. For example, PTL 1 discloses a ceramic heater and a method of manufacturing the ceramic heater in which a resistance heating element is provided on a surface of a ceramic substrate. PTL 1 also discloses that the resistance of the resistance heating element is adjusted by radiating laser light to the resistance heating element so as to form a groove after the resistance heating element of a predetermined pattern has been formed on the surface of the ceramic substrate. Meanwhile, PTL 2 discloses an electrode-containing sintered body used as a ceramic heater. PTL 2 discloses a method of manufacturing the electrode-containing sintered body as follows: an alumina sintered body or an alumina calcined body is formed; electrode paste is printed on the alumina sintered body or the alumina calcined body; alumina powder is charged on the electrode paste so as to be molded, and the molded body is subjected to hot press firing.

### CITATION LIST

### Patent Literature

PTL 1: Japanese Unexamined Patent Application Publication No. 2002-190373

PTL 2: Japanese Unexamined Patent Application Publication No. 2005-343733

### SUMMARY OF THE INVENTION

Meanwhile, it is thought that, in order to adjust the resistance of the electrode paste printed on the alumina sintered body or the alumina calcined body described in PTL 2, the laser light is radiated to the electrode paste to form the groove as described in PTL 1. However, when, after the formation of the groove, the alumina powder is charged on the electrode paste and molded, and the molded body is subjected to hot press firing, a gap may be formed near the side wall of the groove in an alumina ceramic substrate. Such a gap is not preferable because it causes degradation of thermal conductivity and thermal uniformity.

The present invention is made to address such a problem, and a main object of the present invention is to improve thermal conductivity and thermal uniformity in a ceramic heater in which a resistance heating element having a recessed groove is embedded in a ceramic substrate.

A method of manufacturing a ceramic heater of the present invention includes the steps of: (a) forming, on a surface of a first ceramic fired layer or an unfired layer, a resistance heating element or a precursor of the resistance heating element in a predetermined pattern; (b) forming a recessed groove along a longitudinal direction of the resistance heating element or the precursor of the resistance heating element by radiating laser light to the resistance heating element or the precursor of the resistance heating element; (c) obtaining a layered body by disposing, on the surface of the first ceramic fired layer or the unfired layer, a second ceramic unfired layer such that the second ceramic unfired layer covers the resistance heating element or the precursor of the resistance heating element; and (d) obtaining the ceramic heater in which the resistance heating element is embedded in a ceramic substrate by performing hot press firing on the layered body, wherein, in the step (b), the recessed groove is formed such that a side wall surface of the recessed groove is inclined relative to the surface of the first ceramic fired layer or the unfired layer.

In the step (b) of the method of manufacturing a ceramic heater, the recessed groove is formed in the resistance heating element or the precursor of the resistance heating element so as to adjust the sectional area of the resistance heating element or the precursor of the resistance heating element (and, in turn, adjust the resistance of the resistance heating element). At this time, the recessed groove is formed such that the side wall surface of the recessed groove is inclined relative to the surface of the first ceramic fired layer or the unfired layer. In the step (d), when a superposed molded body is subjected to the hot press firing, because of the inclination of the side wall surface of the recessed groove, the pressure is applied between the side wall surface of the recessed groove and ceramic powder included in the second ceramic unfired layer, and the superposed molded body is fired in a state in which the side wall surface and the ceramic powder are in close contact with each other. This can prevent formation of the gap between the side wall surface of the recessed groove and the ceramic substrate and increase bonding strength between the side wall surface of the recessed groove and the ceramic substrate. Accordingly, the thermal conductivity and the thermal uniformity of the obtained ceramic heater are improved.

The “ceramic fired layer” is a layer of ceramic having been fired and, for example, may be a layer of a ceramic fired body (sintered body) or a layer of a ceramic calcined body. The “ceramic unfired layer” is a layer of ceramic not having been fired and may be, for example, a layer of ceramic powder or a layer of a ceramic molded body (including a dried molded body, a dried and degreased molded body, a ceramic green sheet, or the like). The “precursor of the resistance heating element” is a substance that is to be fired so as to become the resistance heating element and that is formed by, for example, printing the resistance heating element paste. The “layered body” may be a structure in which the second ceramic unfired layer is disposed on the surface of the first ceramic fired layer or the unfired layer such that the second ceramic unfired layer covers the resistance heating element or the precursor of the resistance heating element or may be a structure in which a different layer (for example, a third ceramic fired layer or an unfired layer with an electrode or a precursor of the electrode provided on the second ceramic unfired layer side) is further superposed on the second ceramic unfired layer.

In the method of manufacturing a ceramic heater according to the present invention, in the step (b), the recessed groove may be formed such that an inclination angle β of the side wall surface of the recessed groove relative to the surface of the first ceramic fired layer or the unfired layer is smaller than or equal to 45°. In this way, the formation of the gap between the side wall surface of the recessed groove and the ceramic substrate can be reliably prevented. When considering the workability, it is preferable that the inclination angle β of the side wall surface of the recessed groove be greater than or equal to 18°.

In the method of manufacturing a ceramic heater according to the present invention, in the step (b), the recessed groove may be formed such that sectional areas of the resistance heating element or the precursor of the resistance heating element at a plurality of measurement points determined along the longitudinal direction of the resistance heating element or the precursor of the resistance heating element are predetermined target sectional areas, respectively. In this way, the shape of the recessed groove can be determined without measuring the resistance of the resistance heating element or the precursor of the resistance heating element.

In the method of manufacturing a ceramic heater according to the present invention, in the step (b), a depth of the recessed groove may be smaller than or equal to half a thickness of the resistance heating element or the precursor of the resistance heating element. In this way, compared to the case where the depth of the recessed groove is too large, ease of the prevention of the formation of the gap between the ceramic substrate and the side wall surface of the recessed groove increases.

In the method of manufacturing a ceramic heater according to the present invention, in the step (a), the resistance heating element or the precursor of the resistance heating element may be formed such that an end surface of the resistance heating element or the precursor of the resistance heating element along the longitudinal direction of the resistance heating element or the precursor of the resistance heating element is inclined relative to the surface of the first ceramic fired layer or the unfired layer. In this way, the formation of the gap between the ceramic substrate and the end surface of the resistance heating element along the longitudinal direction of the resistance heating element can be prevented and the bonding strength between the end surface and the ceramic substrate can be increased. Accordingly, the thermal conductivity and the thermal uniformity of the obtained ceramic heater are further improved. In this case, in the step (a), it is preferable that the resistance heating element or the precursor of the resistance heating element be formed such that, relative to the surface of the first ceramic fired layer or the unfired layer, an inclination angle of the end surface of the resistance heating element or the precursor of the resistance heating element along the longitudinal direction of the resistance heating element or the precursor of the resistance heating element is smaller than or equal to 45°. In this way, the formation of the gap between the end surface of the resistance heating element along the longitudinal direction of the resistance heating element and the ceramic substrate can be reliably prevented.

In the method of manufacturing a ceramic heater according to the present invention, in the step (b), the inclination angle of the side wall surface of the recessed groove may be greater than the inclination angle of the end surface of the resistance heating element or the precursor of the resistance heating element along the longitudinal direction of the resistance heating element or the precursor of the resistance heating element. The height of the precursor of the resistance heating element is greater than the depth of the recessed groove. Thus, when the inclination of the end surface of the resistance heating element or the precursor of the resistance heating element along the longitudinal direction of the resistance heating element or the precursor of the resistance heating element is gentler, the formation of the gap between the ceramic substrate and the end surface of the resistance heating element of the ceramic heater can be further prevented.

A ceramic heater of the present invention is the ceramic heater, wherein, a resistance heating element is embedded in a ceramic substrate, wherein the ceramic heater includes a recessed groove provided, along a longitudinal direction of the resistance heating element, in a surface of the resistance heating element, and a side wall surface of the recessed groove inclined relative to a surface of the ceramic substrate, wherein no gap exists between the side wall surface of the recessed groove and the ceramic substrate.

In this ceramic heater, the side wall surface of the recessed groove is inclined relative to the surface of the ceramic substrate, and no gap exists between the side wall surface of the recessed groove and the ceramic substrate. Accordingly, the thermal conductivity and the thermal uniformity of the ceramic heater are improved. Such a ceramic heater can be obtained by, for example, performing the above-described method of manufacturing a ceramic heater. It is preferable that an inclination angle α of the side wall surface of the recessed groove relative to the surface of the ceramic substrate be smaller than or equal to 27°. When considering the workability, it is preferable that the inclination angle α be greater than or equal to 10°.

In the ceramic heater according to the present invention, an opening edge of the recessed groove are chamfered. In this way, compared to the case where the opening edge of the recessed groove is angulated, the likelihood of cracking originated from the opening edge of the recessed groove decreases.

In the ceramic heater according to the present invention, it is preferable that a depth of the recessed groove be smaller than or equal to half a thickness of the resistance heating element.

In the ceramic heater according to the present invention, an end surface of the resistance heating element along the longitudinal direction of the resistance heating element may be inclined relative to the surface of the ceramic substrate, and a gap does not necessarily exist between the end surface and the ceramic substrate. In this way, the thermal conductivity and the thermal uniformity of the obtained ceramic heater are further improved. It is preferable that an inclination angle γ of the end surface of the resistance heating element along the longitudinal direction of the resistance heating element relative to the surface of the ceramic substrate is smaller than or equal to 27°.

In the ceramic heater according to the present invention, the inclination angle of the end surface of the resistance heating element along the longitudinal direction of the resistance heating element be smaller than the inclination angle of the side wall surface of the recessed groove.

### BRIEF DESCRIPTION OF THE DRAWINGS

FIG. 1 is a perspective view of an electrostatic chuck heater 10.

FIG. 2 is a sectional view taken along line A-A illustrated in FIG. 1.

FIG. 3 is an explanatory view when a resistance heating element 16 is seen in plan view.

FIG. 4 is a sectional view taken along line B-B illustrated in FIG. 3.

FIGS. 5A to 5F are manufacturing step diagrams of the electrostatic chuck heater 10.

FIG. 6 is a sectional view when a resistance heating element precursor 66 is cut along a surface including the width direction of the resistance heating element precursor 66.

FIG. 7 is an explanatory view of a step of forming a recessed groove 67 in the resistance heating element precursor 66.

FIG. 8 is a sectional view of linear grooves 68.

FIG. 9 is a sectional view of the recessed groove 67.

FIG. 10 is a graph illustrating a result of measurement of the shape of the recessed groove 67 according to example 1.

FIG. 11 is an explanatory view of a method of obtaining an inclination angle β.

FIG. 12 is a histogram in which the height of the resistance heating element precursor 66 is represented along the horizontal axis and the frequency is represented along the vertical axis.

### DETAILED DESCRIPTION OF THE INVENTION

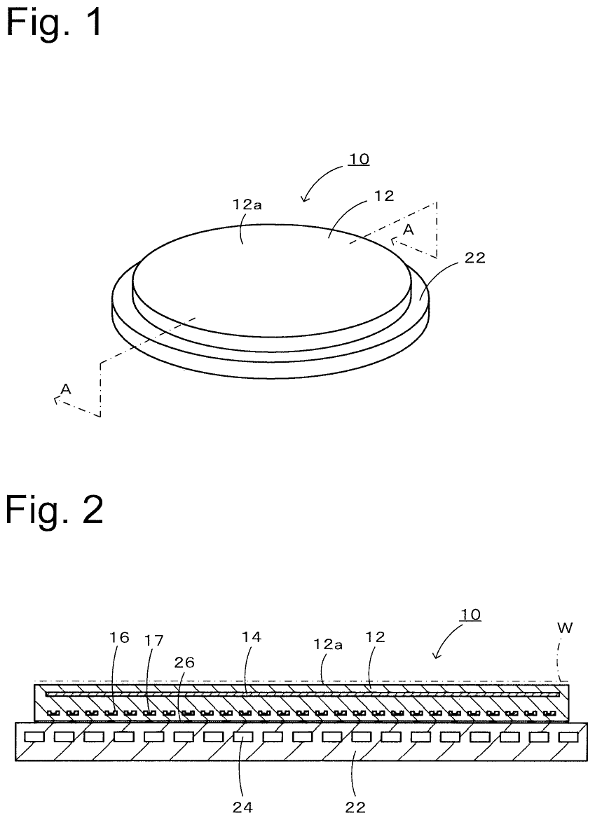

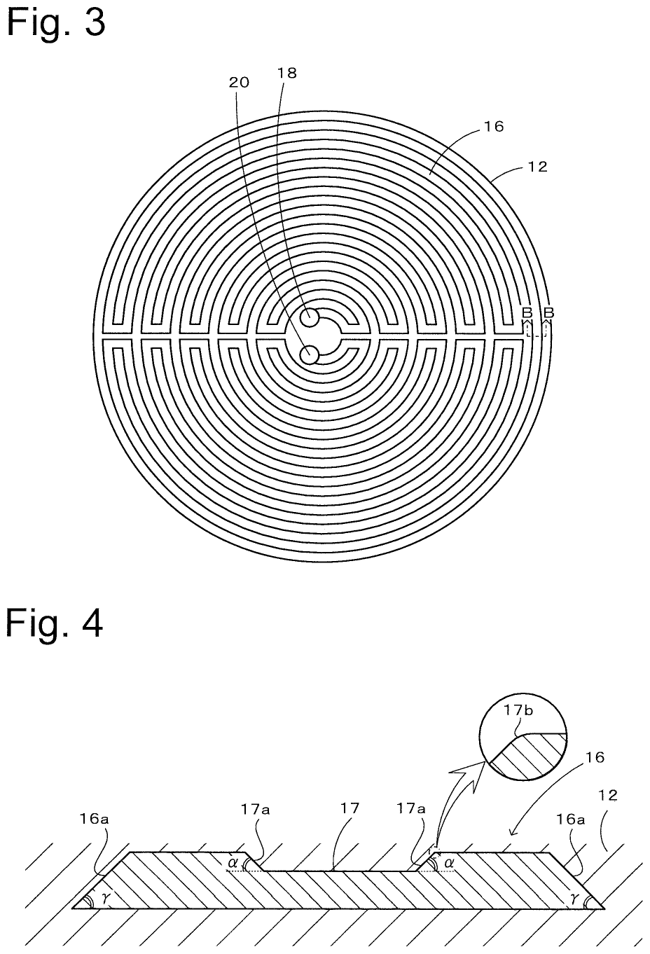

Next, an embodiment of the present invention is described with reference to the drawings. FIG. 1 is a perspective view of an electrostatic chuck heater 10 according to the present embodiment, FIG. 2 is a sectional view taken along line A-A illustrated in FIG. 1, FIG. 3 is an explanatory view when a resistance heating element 16 is seen in plan view, and FIG. 4 is a sectional view taken along line B-B illustrated in FIG. 3.

The electrostatic chuck heater 10 is formed by embedding an electrostatic electrode 14 and the resistance heating element 16 in a ceramic substrate 12. A cooling plate 22 is bonded to a rear surface of the electrostatic chuck heater 10 with a bonding layer 26 interposed therebetween.

The ceramic substrate 12 is a circular plate formed of ceramics (for example alumina or aluminum nitride). A wafer placement surface 12a on which a wafer W can be placed is provided on a surface of the ceramic substrate 12.

The electrostatic electrode 14 is a conductive thin film that is disposed substantially parallel to the wafer placement surface 12a and has a circular shape. A rod-shaped terminal (not illustrated) is electrically connected to this electrostatic electrode 14. The rod-shaped terminal extends downward from a lower surface of the electrostatic electrode 14 through the ceramic substrate 12 and the cooling plate 22. The rod-shaped terminal is electrically insulated from the cooling plate 22. Part of the ceramic substrate 12 above the electrostatic electrode 14 functions as a dielectric layer. Examples of the material of the electrostatic electrode 14 include, for example, tungsten carbide, metallic tungsten, molybdenum carbide, metallic molybdenum, and the like. Out of these, it is preferable that a material having a thermal expansion coefficient close to that of the ceramic to be used be selected.

The resistance heating element 16 is a conductive line that is provided on a surface substantially parallel to the wafer placement surface 12a and has a strip shape. Although none of the width, the thickness, and the distance between turns of the strip-shaped conductive line is particularly limited, the width, the thickness, and the distance between the turns of the strip-shaped conductive line may be set to, for example, 0.1 to 10 mm, 0.001 to 0.1 mm, and 0.1 to 5 mm, respectively. The resistance heating element 16 is formed by the strip-shaped conductive line routed in a one-stroke pattern from one terminal portion 18 to another terminal portion 20 throughout the ceramic substrate 12 such that the turns of the strip-shaped conductive line do not intersect each other. Power feed terminals (not illustrated) are respectively electrically connected to the terminal portions 18, 20 of the resistance heating element 16. The power feed terminals extend downward from a lower surface of the resistance heating element 16 through the ceramic substrate 12 and the cooling plate 22 under the ceramic substrate 12. The power feed terminals are electrically insulated from the cooling plate 22. Examples of the material of the resistance heating element 16 include, for example, tungsten carbide, metallic tungsten, molybdenum carbide, metallic molybdenum, and the like. Out of these, it is preferable that a material having a thermal expansion coefficient close to that of the ceramic to be used be selected.

As illustrated in FIG. 4, a recessed groove 17 is provided in a surface of the resistance heating element 16 along a longitudinal direction (a direction in which current flows) of the resistance heating element 16. Although the depth of the recessed groove 17 is, by definition, smaller than the thickness of the resistance heating element 16, it is preferable that the depth of the recessed groove 17 be smaller than or equal to a half the thickness of the resistance heating element 16. Side wall surfaces 17a of the recessed groove 17 are inclined relative to the wafer placement surface 12a of the ceramic substrate 12. No gap exists between each of the side wall surfaces 17a of the recessed groove 17 and the ceramic substrate 12. The term “no gap exists” refers to a state in which no gap is found when a scanning electron microscope (SEM) section of the ceramic substrate 12 at a 150-fold magnification is observed by the naked eye (hereinafter, the same). It is preferable that the inclination angle α of the side wall surface 17a relative to the wafer placement surface 12a be smaller than or equal to 27°. When considering the workability, it is also preferable that this inclination angle α be greater than or equal to 10°. It is preferable that the width of the recessed groove 17 be greater than or equal to the depth of the recessed groove 17. Opening edges 17b of the recessed groove 17 are not angulated, but rather, each of the opening edges 17b is chamfered. The opening edge 17b may be C chamfered or R chamfered. End surfaces 16a along the longitudinal direction of the resistance heating element 16 are inclined relative to the wafer placement surface 12a of the ceramic substrate 12. No gap exists between each of the end surfaces 16a and the ceramic substrate 12. It is preferable that the inclination angle γ of the end surface 16a relative to the wafer placement surface 12a be smaller than or equal to 27°. It is preferable that the inclination angle γ of the end surface 16a of the resistance heating element 16 be smaller than the inclination angle α of the side wall surface 17a of the recessed groove 17.

The cooling plate 22 is formed of metal (for example, aluminum) and has therein a coolant path 24 that allows a coolant (for example, water) to pass therethrough. The coolant path 24 is formed so that the coolant passes through the entirety of the ceramic substrate 12. The coolant path 24 is provided with an inlet and outlet for the coolant (neither of the inlet nor the outlet is illustrated).

Next, an example of use of the electrostatic chuck heater 10 is described. When the wafer W is placed on the wafer placement surface 12a of the electrostatic chuck heater 10 and a voltage is applied between the electrostatic electrode 14 and the wafer W, the wafer W is attracted to the wafer placement surface 12a by an electrostatic force. In this state, the wafer W is subjected to plasma etching or film formation by a plasma chemical vapor deposition (CVD). The temperature of the wafer W is controlled so that the temperature of the wafer W is maintained at a certain temperature by applying the voltage to the resistance heating element 16 to heat the wafer W or circulating the coolant through the coolant path 24 of the cooling plate 22 to cool the wafer W. When applying the voltage to the resistance heating element 16, the voltage is applied between the one terminal portion 18 and the other terminal portion 20 of the resistance heating element 16. This causes the current to flow through the resistance heating element 16, thereby the resistance heating element 16 generates heat to heat the wafer W.

According to the present embodiment, the recessed groove 17 is formed in the surface of the resistance heating element 16. A region of the resistance heating element 16 from the one terminal portion 18 to the other terminal portion 20 is divided into a plurality of sections, and the width of the recessed groove 17 is determined on a section-to-section basis (the depth of the recessed groove 17 is substantially uniform). In a section where the width of the recessed groove 17 is large, the resistance increases and the amount of heat generation increases due to a decrease in sectional area of the resistance heating element 16. In a section where the width of the recessed groove 17 is small, the resistance decreases and the heat generation amount decreases due to an increase in sectional area of the resistance heating element 16. Accordingly, the heat generation amounts for the sections of the resistance heating element 16 are matched to respective target heat generation amounts by adjusting the width of the recessed groove 17 of the sections.

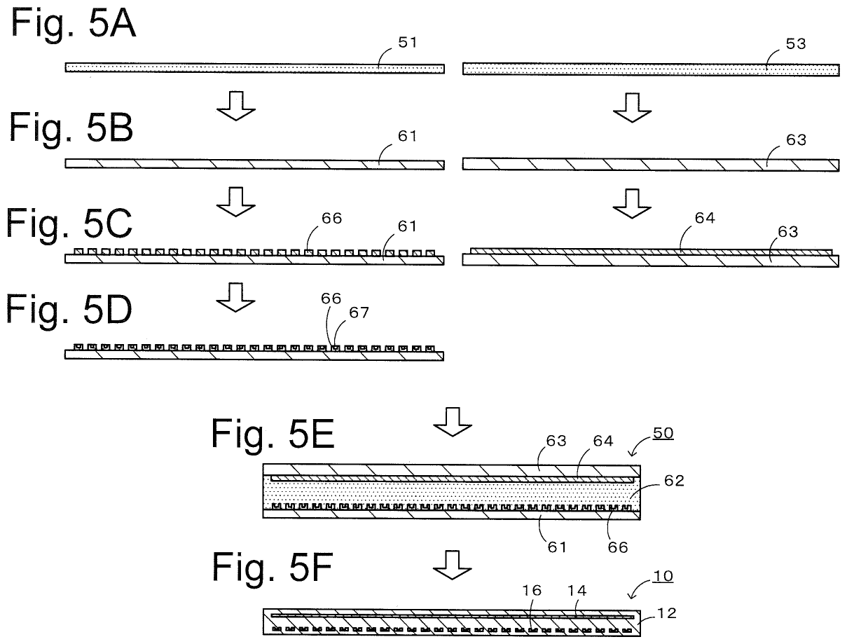

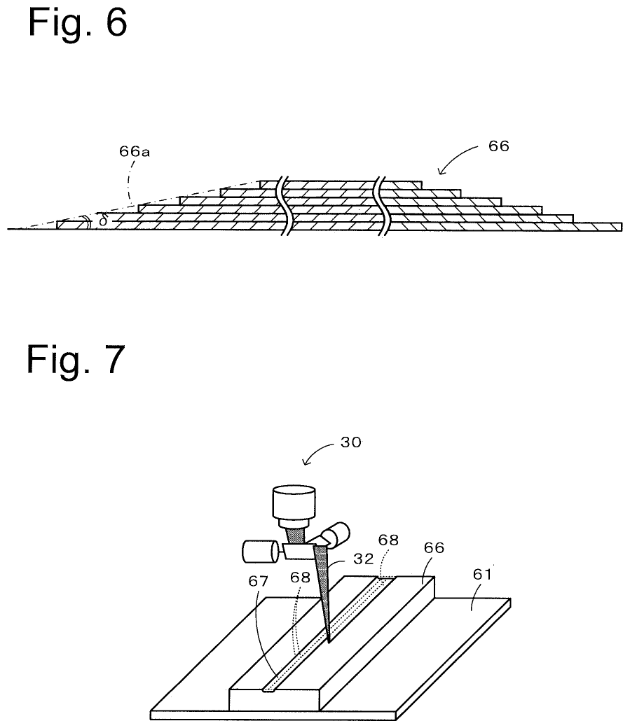

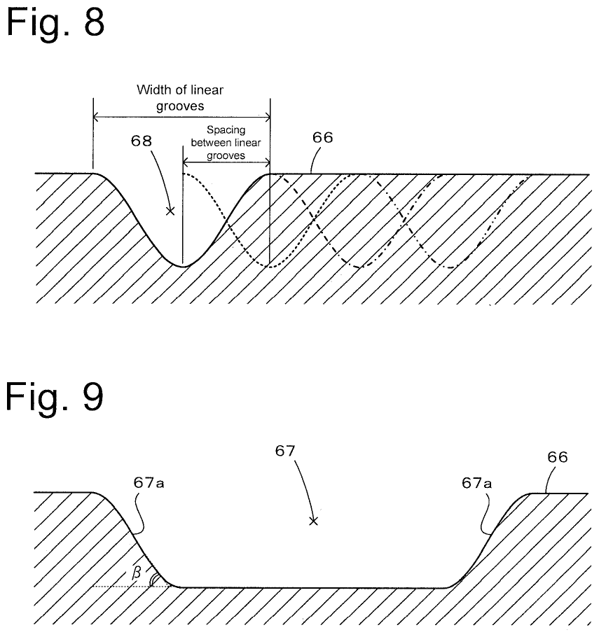

Next, an example of the manufacture of the electrostatic chuck heater 10 is described. FIGS. 5A to F are manufacturing step diagrams of the electrostatic chuck heater 10, FIG. 6 is a sectional view of a resistance heating element precursor 66 when the resistance heating element precursor 66 is vertically cut along a surface including the width direction of the resistance heating element precursor 66, FIG. 7 is an explanatory view of a step of forming a recessed groove 67 in the resistance heating element precursor 66, and FIGS. 8 and 9 are sectional views of linear grooves 68 and the recessed groove 67, respectively, when the resistance heating element precursor 66 is vertically cut along the surface including the width direction of the resistance heating element precursor 66. Hereinafter, a case in which an alumina substrate is manufactured as the ceramic substrate 12 is described as the example.

1. Fabricating of Molded Bodies (see FIG. 5A)

Disc-shaped upper and lower molded bodies 51, 53 are fabricated. Each of the molded bodies 51, 53 is fabricated, for example, first, by charging slurry including alumina powder (for example, having an average particle size of 0.1 to 10 μm), a solvent, a dispersant, and a gelling agent into a mold, making the slurry gelate by causing a chemical reaction of the gelling agent in the mold, and then, releasing from the mold is performed. The molded bodies 51, 53 obtained as described above are referred to as mold casting molded bodies.

The solvent is not particularly limited as long as the dispersant and the gelling agent become dissolved in the solvent. Examples of the solvent include, for example, hydrocarbon-based solvents (toluene, xylene, solvent naphtha, and the like), ether-based solvents (ethylene glycol monoethyl ether, butyl carbitol, butyl carbitol acetate, and the like), alcohol-based solvents (isopropanol, 1-butanol, ethanol, 2-ethyl hexanol, terpineol, ethylene glycol, glycerin, and the like), ketone-based solvents (acetone, methyl ethyl ketone, and the like), ester-based solvents (butyl acetate, glutaric acid dimethyl, triacetin, and the like), and polybasic acid-based solvents (glutaric acid and the like). In particular, it is preferable that a solvent having two or more ester bonds such as a polybasic acid ester (for example, glutaric acid dimethyl or the like), an acid ester of a polyhydric alcohol (for example, triacetin or the like) be used.

The dispersant is not particularly limited as long as the alumina powder uniformly disperses in the solvent. Examples of the dispersant include, for example, a polycarboxylic acid-based copolymer, a polycarboxylate, a polysorbate, a polyglycerol ester, a phosphate ester salt-based copolymer, a sulfonate-based copolymer, a polyurethane polyester-based copolymer having tertiary amine, and the like. In particular, it is preferable that a polycarboxylic acid-based copolymer, a polycarboxylate, or the like be used. When this dispersant is added, the slurry before the molding can have a low viscosity and a high fluidity.

The gelling agent can include, for example, isocyanates, polyols, and a catalyst. Out of these, the isocyanates are not particularly limited as long as the isocyanates are substances having an isocyanate group as a functional group, and examples of the isocyanates include, for example, a tolylenediisocyanate (TDI), a diphenylmethane diisocyanate (MDI), denatured substances of these, and the like. In a molecule, a functional group other than the isocyanate group may be included. Furthermore, many reactive functional groups may be included as is the case with a polyisocyanate. The polyols are not particularly limited as long as the polyols are substances having two or more hydroxy groups that can react with the isocyanate group. Examples of the polyols include, for example, ethylene glycol (EG), polyethylene glycol (PEG), propylene glycol (PG), polypropylene glycol (PPG), polytetramethylene glycol (PTMG), polyhexamethylene glycol (PHMG), polyvinyl alcohol (PVA), and the like. The catalyst is not particularly limited as long as the catalyst is a substance that promotes urethane reaction between the isocyanates and the polyols. Examples of the catalyst include, for example, triethylenediamine, hexanediamine, 6-dimethylamino-1-hexanol, and the like.

It is preferable that this step be performed as follows: first, a slurry precursor is prepared by adding the solvent and the dispersant to the alumina powder in predetermined proportions and mixing these for a predetermined length of time; and then, the slurry is obtained by adding the gelling agent to the slurry precursor, mixing the gelling agent and the slurry precursor, and vacuum deaerating the mixture. A method of mixing for preparing the slurry precursor and the slurry is not particularly limited. For example, a ball mill, planetary centrifugal mixing, vibrating mixing, propeller mixing, or the like is usable. Since the chemical reaction (urethane reaction) of the gelling agent starts to progress over time, it is preferable that the slurry obtained by adding the gelling agent to the slurry precursor be quickly poured into the mold. The slurry having poured into the mold gelates when the gelling agent included in the slurry undergoes chemical reaction. The chemical reaction of the gelling agent is a reaction in which urethane resin (polyurethane) is produced by the occurrence of the urethane reaction between the isocyanates and the polyols. The slurry gelates due to the reaction of the gelling agent, and the urethane resin functions as an organic binder.

2. Fabricating of Calcined Bodies (see FIG. 5B)

The upper and lower molded bodies 51, 53 having been dried are then degreased, and further, calcined to obtain calcined bodies 61, 63. The molded bodies 51, 53 are dried so as to evaporate the solvent included in the molded bodies 51, 53. The drying temperature and the drying time can be appropriately set in accordance with the solvent in use. However, the drying temperature is carefully set so as not to allow cracking of the molded bodies 51, 53 under drying. The atmosphere may be any one of an air atmosphere, an inert atmosphere, and a vacuum atmosphere. The molded bodies 51, 53 having been dried are degreased so as to decompose and remove the organic substances such as the dispersant, the catalyst, or the binder. The degrease temperature can be appropriately set in accordance with the types of the included organic substances. For example, the degrease temperature may be set to 400 to 600° C. The atmosphere may be any one of an air atmosphere, an inert atmosphere, and a vacuum atmosphere. The degreased molded bodies 51, 53 are calcined so as to increase the strength and ease of handling. The calcination temperature is not particularly limited. For example, the calcination temperature may be set to 750 to 900° C. The atmosphere may be any one of an air atmosphere, an inert atmosphere, and a vacuum atmosphere.

3. Forming of Resistance Heating Element Precursor (See FIG. 5C and FIG. 6)

The resistance heating element precursor 66 is formed by printing paste for the resistance heating element on one of surfaces of the lower calcined body 61 such that the paste for the resistance heating element has the same pattern as that of the resistance heating element 16 and, then, drying the paste for the printed resistance heating element. Also, an electrostatic electrode precursor 64 is formed by printing paste for the electrostatic electrode on one of surfaces of the upper calcined body 63 such that the paste for the electrostatic electrode has the same pattern as that of the electrostatic electrode 14 and, then, drying the paste for the electrostatic electrode. Both of types of the paste include alumina powder, conductive powder, a binder, and a solvent. As the alumina powder, alumina powder similar to that used for, for example, fabricating the molded bodies 51, 53 may be used. Examples of the conductive powder include, for example, tungsten carbide powder. Examples of the binder include, for example, cellulose-based binders (ethyl cellulose and the like), acrylic-based binders (polymethyl methacrylate and the like), vinyl-based binders (polyvinyl butyral and the like). Examples of the solvent include, for example, terpineol and the like. Examples of a method of printing include, for example, a screen printing method and the like. The printing is performed a plurality of number of times. Thus, each of the precursors 66, 64 has a multilayered structure. Furthermore, the resistance heating element precursor 66 is printed such that end surfaces 66a of the resistance heating element precursor 66 along the longitudinal direction have a stepped shape (see FIG. 6). Since an end portion of the printed paste flows downward, each of the end surfaces 66a becomes an inclined surface instead of being a surface having the stepped shape at last. The end surface 66a is inclined relative to a surface of the lower calcined body 61. It is preferable that an inclination angle δ of the end surface 66a is smaller than or equal to 45°. Although it is not illustrated, the electrostatic electrode precursor 64 is printed so as to have a stepped shape similarly to this. Also in this case, since the end portion of the printed paste flows downward, the end surface becomes an inclined surface instead of a step-shaped surface.

4. Forming of Recessed Groove (See FIG. 5D and FIGS. 7 to 9)

The recessed groove 67 is formed in the resistance heating element precursor 66 provided on the one surface of the lower calcined body 61. It is preferable that the depth of the recessed groove 67 be smaller than or equal to half the resistance heating element precursor 66. The recessed groove 67 is formed by a pico-second laser machining system 30 illustrated in FIG. 7. The pico-second laser machining system 30 radiates laser light 32 along the longitudinal direction of the resistance heating element precursor 66 while driving a motor for a galvano mirror and a motor for a stage, thereby forming the linear grooves 68. The width of the linear grooves 68 (groove width formed in a single path) is not particularly limited. For example, the width of the linear grooves 68 is preferably 10 to 100 μm, and more preferably 20 to 60 μm. The pico-second laser machining system 30 provides a plurality of such linear grooves 68 so as to overlap each other in the width direction of the resistance heating element precursor 66, thereby forming the recessed groove 67. In the laser light 32, the energy is highest at the center of the irradiated portion and decreases as the distance from the center increases. Thus, the section of the generated linear grooves 68 have a shape close to a sine curve as illustrated in FIG. 8. When the spacing between the linear grooves 68 is set to half the width of the linear grooves 68, the section of the laser light 32 for forming the next linear groove 68 from the current linear groove 68 is as indicated by a dotted line illustrated in FIG. 8, the section of the laser light 32 for forming the linear groove 68 following the next linear groove 68 is as indicated by a one-dot chain line illustrated in FIG. 8, and the section of the laser light 32 for forming the linear groove 68 following the following linear groove 68 is as indicated by a two-dot chain line illustrated in FIG. 8. Thus, when all the linear grooves 68 have been formed, the recessed groove 67 having a bottom surface the shape of which is close to a substantially flat shape is obtained as illustrated in FIG. 9. The recessed groove 67 is an aggregation of the linear grooves 68. Side wall surfaces 67a of the recessed groove 67 are inclined relative to the surface of the lower calcined body 61. It is preferable that an inclination angle β of each of the side wall surfaces 67a of the recessed groove 67 relative to the surface of the lower calcined body 61 (see FIG. 9) be smaller than or equal to 45°. When considering the workability with the laser light 32, it is preferable that the inclination angle β be greater than or equal to 18°. The inclination angle β varies depending on the output of the laser light 32 and the number of times of processing with the laser light 32 (number of times of irradiation with the laser light 32 at the same position). At this time, it is preferable that the inclination angle β be greater than the inclination angle δ, in other words, the inclination angle δ be set to be gentler than the inclination angle β.

To form the recessed groove 67, first, a distribution of the thickness of the resistance heating element precursor 66 before the formation of the recessed groove 67 is measured by using a laser displacement meter. This measurement is performed at a plurality of measurement points predetermined along the center line of the resistance heating element precursor 66. For each of the measurement points, the difference between a predetermined target value of the thickness and a measured value of the thickness (difference in thickness) is obtained. The target value of the thickness is set based on a target value of the resistance when the resistance heating element precursor 66 is fired to obtain the resistance heating element 16. Then, based on the difference in thickness at a certain measurement point, the number of the linear grooves 68 formed in a section from the certain measurement point to the adjacent measurement point is determined. The depth of the linear grooves 68 is a predetermined value. Thus, when the number of the linear grooves 68 is varied, the width of the recessed groove 67 varies, the sectional area of the recessed groove 67 varies and, further, the sectional area of the resistance heating element precursor 66 varies. That is, the recessed groove 67 is formed so that the sectional areas of the resistance heating element precursor 66 at the plurality of measurement points are the predetermined target sectional areas, respectively.

5. Fabricating of Layered Body (see FIG. 5E)

The alumina powder is superposed on the surface of the lower calcined body 61 on which the resistance heating element precursor 66 is provided such that the alumina powder covers the resistance heating element precursor 66, the upper calcined body 63 is superposed on the alumina powder such that the surface on which the electrostatic electrode precursor 64 is provided is in contact with the alumina powder, and molded. In this way, a layered body 50 is obtained. The layered body 50 has a structure in which an alumina powder layer 62 is sandwiched between the upper and lower calcined bodies 61, 63. As the alumina powder, alumina powder similar to that used for fabricating the molded bodies 51, 53 may be used.

6. Hot Press Firing (See FIG. 5F)

The obtained layered body 50 is subjected to hot press firing with the pressure applied in the thickness direction. At this time, since the layered body 50 is blocked by the mold so as not to expand in the radial direction, the layered body 50 is compressed in the thickness direction. Although the compressibility varies depending on the pressure for the pressing, the compressibility is, for example, 30 to 70%. In this way, the resistance heating element precursor 66 is fired and becomes the resistance heating element 16, the electrostatic electrode precursor 64 is fired and becomes the electrostatic electrode 14, and the calcined bodies 61, 63 and the alumina powder layer 62 are sintered, integrated with each other, and become the ceramic substrate 12. As a result, the electrostatic chuck heater 10 is obtained. The hot press firing is preferably performed at least at a maximum temperature (firing temperature) and the pressure for the pressing of 30 to 300 kgf/cm², and more preferably, at 50 to 250 kgf/cm². Although the maximum temperature can be appropriately set depending on the type, the particle size, and the like of the ceramic powder, it is preferable that the maximum temperature be set in a range from 1000 to 2000° C. The atmosphere can be appropriately selected from among an air atmosphere, an inert atmosphere, and a vacuum atmosphere.

Here, correspondence between the elements of the present embodiment and the elements of the present invention is clarified. The electrostatic chuck heater 10 of the present embodiment corresponds to a ceramic heater of the present invention. Also, the forming of the resistance heating element precursor of the present embodiment (see FIG. 5C and FIG. 6) corresponds to step (a) of the present invention, the forming of the recessed groove (see FIG. 5D and FIGS. 7 to 9)) corresponds to step (b), the fabricating of the layered body (see FIG. 5E) corresponds to step (c), the hot press firing (see FIG. 5F) corresponds to step (d), the calcined body 61 corresponds to a first ceramic fired layer, and the alumina powder layer 62 corresponds to a second ceramic unfired layer.

According to the present embodiment having been described in detail above, the recessed groove 67 is formed in the resistance heating element precursor 66 so as to adjust the sectional area of the resistance heating element precursor 66 (and, in turn, adjust the resistance of the resistance heating element 16). At this time, the recessed groove 67 is formed such that the side wall surface 67a of the recessed groove 67 is inclined relative to the surface of the lower calcined body 61. When the layered body 50 is subjected to the hot press firing, because of the inclination of the side wall surface 67a of the recessed groove 67, the pressure is applied between the side wall surface 67a of the recessed groove 67 and the alumina powder included in the alumina powder layer 62, and the layered body 50 is fired in a state in which the side wall surface 67a and the alumina powder are in close contact with each other. In the electrostatic chuck heater 10, this can prevent formation of the gap between the side wall surface 17a of the recessed groove 17 and the ceramic substrate 12 and increase bonding strength between the side wall surface 17a of the recessed groove 17 and the ceramic substrate 12. Accordingly, the thermal conductivity and the thermal uniformity of the obtained electrostatic chuck heater 10 are improved.

Furthermore, when the inclination angle β of the side wall surface 67a of the recessed groove 67 relative to the surface of the calcined body 61 is smaller than or equal to 45°, formation of the gap between the ceramic substrate 12 and the side wall surface 17a of the recessed groove 17 of the resistance heating element 16 of the electrostatic chuck heater 10 can be reliably prevented. When considering the workability (for example, the number of times of processing with the laser light and the like), the inclination angle β be greater than or equal to 18°. When the inclination angle β is too small, the depth of the recessed groove 17 formed by a single operation of the processing with the laser light decreases. Thus, the number of times of the processing for forming the depth of the recessed groove 17 having a predetermined depth increases, and accordingly, the processing time increases.

Furthermore, the recessed groove 67 is formed so that the sectional areas of the resistance heating element precursor 66 at the plurality of measurement points determined along the longitudinal direction are the predetermined target sectional areas, respectively. Accordingly, the shape of the recessed groove 67 can be determined without measuring the resistance of the resistance heating element precursor 66.

It is preferable that the depth of the recessed groove 67 be set to be smaller than or equal to half the thickness of the resistance heating element precursor 66. In this way, compared to the case where the depth of the recessed groove 67 is too large, ease of the prevention of the formation of the gap between the ceramic substrate 12 and the side wall surface 17a of the recessed groove 17 of the electrostatic chuck heater 10 increases.

Furthermore, the end surface 66a of the resistance heating element precursor 66 along the longitudinal direction of the resistance heating element precursor 66 is inclined relative to the surface of the calcined body 61. Thus, the formation of the gap between the ceramic substrate 12 and the end surface 16a of the resistance heating element 16 along the longitudinal direction of the resistance heating element 16 of the electrostatic chuck heater 10 can be prevented and the bonding strength between the end surface 16a and the ceramic substrate 12 can be increased. Accordingly, the thermal conductivity and the thermal uniformity of the obtained electrostatic chuck heater 10 are further improved. In particular, when the inclination angle δ of the end surface of the resistance heating element precursor 66 along the longitudinal direction of the resistance heating element precursor 66 relative to the surface of the calcined body 61 is smaller than or equal to 45°, the formation of the gap between the ceramic substrate 12 and the end surface 16a of the resistance heating element 16 along the longitudinal direction of the resistance heating element 16 can be reliably prevented.

In forming the recessed groove 67, it is preferable that the inclination angle α of the side wall 67a of the recessed groove 67 be greater than the inclination angle δ of the end surface 66a of the resistance heating element precursor 66, in other words, the inclination angle δ be set to be gentler than the inclination angle β. The height of the resistance heating element precursor 66 is greater than the depth of the recessed groove 67. Thus, when the inclination of the end surface 66a of the resistance heating element precursor 66 is gentler, the formation of the gap between the ceramic substrate 12 and the end surface 16a of the resistance heating element 16 of the electrostatic chuck heater 10 can be further prevented.

In the electrostatic chuck heater 10, the side wall surface 17a of the recessed groove 17 is inclined relative to the surface of the ceramic substrate 12, and no gap exists between the side wall surface 17a of the recessed groove 17 and the ceramic substrate 12. Accordingly, the thermal conductivity and the thermal uniformity of the electrostatic chuck heater 10 are improved. It is preferable that the inclination angle α of the side wall surface 17a of the recessed groove 17 relative to the surface of the ceramic substrate 12 be smaller than or equal to 27°. Also, it is preferable that the inclination angle α be greater than or equal to 10°. In order to more reliably prevent the formation of the gap between the side wall surface 17a of the recessed groove 17 and the ceramic substrate 12, it is preferable that the width of the recessed groove 17 be set to be greater than or equal to the depth of the recessed groove 17.

Also in the electrostatic chuck heater 10, the opening edge 17b of the recessed groove 17 is chamfered. Accordingly, compared to the case where the opening edge of the recessed groove 17 is angulated, the likelihood of cracking originated from the opening edge 17b of the recessed groove 17 decreases. It is noted that, even when the opening edge of the recessed groove 67 before the hot press firing is performed is angulated, the opening edge 17b of the recessed groove 17 after the hot press firing has been performed is chamfered. It is preferable that the depth of the recessed groove 17 be smaller than or equal to half the thickness of the resistance heating element 16.

Furthermore, in the electrostatic chuck heater 10, the end surface 16a of the resistance heating element 16 along the longitudinal direction of the resistance heating element 16 are inclined relative to the surface of the ceramic substrate 12, and no gap exists between the end surface 16a and the ceramic substrate 12. Accordingly, the thermal conductivity and the thermal uniformity of the electrostatic chuck heater 10 are further improved. It is preferable that, relative to the surface of the ceramic substrate 12, the inclination angle γ of the end surface 16a of the resistance heating element 16 along the longitudinal direction of the resistance heating element 16 be smaller than or equal to 27°. It is preferable that the inclination angle γ be smaller than the inclination angle α of the side wall surface 17a of the recessed groove 17.

Of course, the present invention is not in any way limited to the above-described embodiment, and the present invention can be carried out in a variety of forms as long as the forms belong to the technical scope of the present invention.

For example, although the ceramic heater is exemplified by the electrostatic chuck heater 10 according to the above-described embodiment, the ceramic heater may be a ceramic heater that does not include the electrostatic electrode 14. In this case, the layered body 50 may be fabricated by using the upper calcined body 63 having no electrostatic electrode precursor 64 and subjected to hot press firing, or the layered body 50 from which the upper calcined body 63 is omitted may be fabricated and subjected to hot press firing.

Although the second ceramic unfired layer is exemplified by the alumina powder layer 62 according to the above-described embodiment, an alumina molded body layer or an alumina green sheet may be used instead of the alumina powder layer 62. A dried alumina molded body layer may be used, or an alumina molded body layer degreased after being dried may be used.

Although the first ceramic fired layer is exemplified by the calcined body 61 according to the above-described embodiment, an alumina sintered body may be used instead of the calcined body 61. Alternatively, a ceramic molded body layer or a ceramic green sheet may be used instead of the first ceramic fired layer. A dried ceramic molded body layer may be used, or a ceramic molded body layer degreased after being dried may be used.

Although the paste for the resistance heating element having been printed and, then, dried is used as the resistance heating element precursor 66 in which the recessed groove 67 is formed according to the above-described embodiment, the paste for the resistance heating element may be degreased after the paste for the resistance heating element has been printed and dried or may be calcined (or fired) after the paste for the resistance heating element has been printed, dried, and degreased.

Although the strip-shaped conductive line routed in a one-stroke pattern throughout the ceramic substrate 12 such that the turns of the strip-shaped conductive line do not intersect each other is employed as the resistance heating element 16 according to the above-described embodiment, this is not limiting. For example, the ceramic substrate 12 may be divided into a plurality of zones, and, in each zone, a corresponding one of resistance heating elements may be provided by routing the corresponding strip-shaped conductive line in a one-stroke pattern such that the turns of the strip-shaped conductive line do not intersect each other. In this case, a structure similar to that of the above-described resistance heating element 16 can be employed for each resistance heating element.

### EXAMPLES

Hereinafter, examples of the present invention are described. It is noted that the following examples do not in any way limit the present invention.

### Example 1

According to the above-described example of the manufacture, the electrostatic chuck heater 10 was fabricated (see FIGS. 5A to 5F).

### 1. Fabricating of Molded Bodies

100 parts by weight of alumina powder (average particle size of 0.5 μm, purity of 99.7%), 0.04 parts by weight of magnesia, 3 parts by weight of polycarboxylic acid-based copolymer as the dispersant, and 20 parts by weight of polybasic acid ester as the solvent were measured, and these were mixed by using a ball mill (trommel) for 14 hours to obtain the slurry precursor. 3.3 parts by weight of 4,4′.diphenylmethane diisocyanate as the gelling agent, that is, the isocyanates, 0.3 parts by weight of ethylene glycol as the polyols, and 0.1 parts by weight of 6.dimethylamino.1.hexanol as the catalyst were added to this slurry precursor and mixed by using a planetary centrifugal mixer for 12 minutes to obtain the slurry. The obtained slurry was poured into the mold. After that, the slurry was left at 22° C. for two hours to cause the gelling agent to undergo a chemical reaction in the mold to gelate the slurry, and then, the slurry was released from the mold. In this way, the upper and lower molded bodies 51, 53 (see FIG. 5A) were obtained.

2. Fabricating of Calcined Bodies

The upper and lower molded bodies 51, 53 were dried at 100° C. for ten hours, then, degreased at the maximum temperature of 500° C. for one hour, and, further, calcined at the maximum temperature of 820° C. for one hour under the air atmosphere, thereby obtaining the upper and lower calcined bodies 61, 63 (see FIG. 5B).

3. Forming of Resistance Heating Element Precursor

Tungsten carbide powder (average particle size of 1.5 μm) and alumina powder (average particle size of 0.5 μm) were mixed so that the alumina content is 10% by weight, and to them polymethyl methacrylate as the binder and terpineol as the solvent were added and mixed, thereby preparing paste. This paste was used for both the resistance heating element and the electrostatic electrode. The resistance heating element precursor 66 having a thickness of 100 μm was formed by performing screen printing with the paste for the resistance heating element on one of the surfaces of the lower calcined body 61 a plurality of times and, then, drying the paste for the printed resistance heating element. Also, the electrostatic electrode precursor 64 was formed by performing screen printing with the paste for the electrostatic electrode precursor on one of the surfaces of the upper calcined body 63 a plurality of times and, then, drying the paste for the electrostatic electrode precursor (see FIG. 5C). The inclination angle δ of the end surface 66a of the resistance heating element precursor 66 was 10°. Since the end portions of the printed paste actually flowed downward, the end surface 66a became an inclined surface instead of being a surface having the stepped shape. The value of the inclination angle of an end surface of the electrostatic electrode precursor 64 was the same.

4. Forming of Recessed Groove

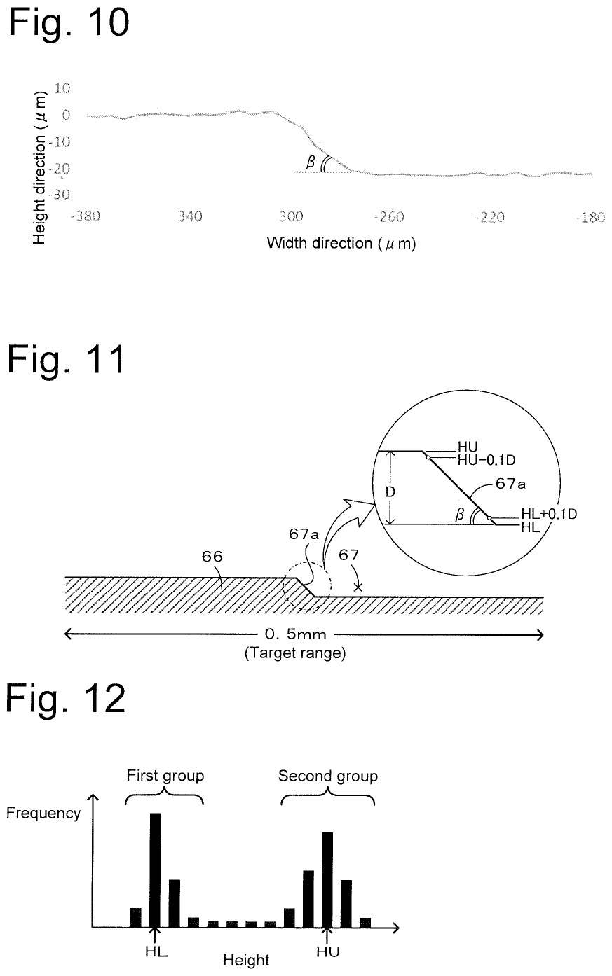

The distribution of the thickness of the resistance heating element precursor 66 was measured by using a laser displacement meter, and, based on the measurement result, the recessed groove 67 was formed in a surface of the resistance heating element precursor 66 by using the pico-second laser machining system 30. As the conditions for laser processing, laser output was set to 20 W, processing speed was set to 2000 mm/sec, and the number of times of processing was set to two. The shape of the formed recessed groove 67 was measured. The result is illustrated in FIG. 10. From FIG. 10, the depth of the recessed groove 67 was 20 μm, and the inclination angle β of the side wall surface 67a of the recessed groove 67 was 34°.

Here, a method of obtaining the inclination angle β is described. As illustrated in FIG. 11, first, a target range of 0.5 mm was set in the width direction such that the side wall surface 67a that is an inclined surface was included in the target range. At this time, correction was made such that a bottom surface of the resistance heating element precursor 66 was substantially horizontal. Also, the center of the target range and the center of the side wall surface 67a substantially matched. The height of the resistance heating element precursor 66 was obtained throughout the target range at 2.5-μm intervals in the width direction. The height was measured by using a contact probe measurement device. A graph (histogram) was drawn in which the height of the resistance heating element precursor 66 is represented along the horizontal axis and the frequency is represented along the vertical axis. The height data was at 1 μm intervals. An example of the histogram is illustrated in FIG. 12. In the histogram, a first group that is smaller in height and a second group that is greater in height appeared. The first group is a group of the height of the bottom surface of the recessed groove 67, and the second group is a group of the height at a top surface (part where the recessed groove 67 is not provided) of the resistance heating element precursor 66. In the histogram, a value of the highest frequency (mode) in the first group was regarded as a bottom surface height HL of the recessed groove 67, and a value of the highest frequency (mode) in the second group was regarded as a top surface height HU of the resistance heating element precursor 66. A value obtained by subtracting HL from HU was defined as a depth D of the recessed groove 67. A value obtained by adding 0.1 D to the HL was defined as a lower limit value, and a value obtained by subtracting 0.1 D from HU was defined as an upper limit value. The regression line of the side wall surface 67a was obtained by using the height measured at 2.5-μm intervals in a range from the lower limit value to the upper limit value of the side wall surface 67a, and an angle that the regression line forms with the horizontal line (horizontal axis illustrated in FIG. 10) was defined as the inclination angle β. The above-described inclination angle δ of the end surface 66a of the resistance heating element precursor 66 was obtained in a manner similar to this. However, to obtain the inclination angle δ, the target range was set to 1.5 mm instead of 0.5 mm.

5. Fabricating of Layered Body

The alumina powder was superposed on the surface of the calcined body 61 on which the resistance heating element precursor 66 was provided such that the alumina powder covered the resistance heating element precursor 66, the calcined body 63 was superposed on the alumina powder such that the surface on which the electrostatic electrode precursor 64 was provided was in contact with the alumina powder, and molded. In this way, the layered body 50 was obtained.

6. Hot Press Firing

The obtained layered body 50 was subjected to hot press firing. Thus, the resistance heating element precursor 66 was fired and became the resistance heating element 16 having a thickness of 50 μm, the electrostatic electrode precursor 64 was fired and became the electrostatic electrode 14, the calcined bodies 61, 63 and the alumina powder layer 62 were sintered, integrated with each other, and became the ceramic substrate 12, and the electrostatic chuck heater 10 was obtained. The hot press firing was performed by holding for two hours under a pressure of 250 kgf/cm² and at the maximum temperature of 1600° C. under a vacuum atmosphere. After that, a surface of the ceramic sintered body was subjected to a surface grinding process by using a diamond whetstone so that a thickness between the electrostatic electrode 14 to the wafer placement surface 12a was 350 μm.

[Evaluation]

When the appearance of the ceramic substrate (alumina substrate) 12 of the obtained electrostatic chuck heater 10 was observed, portions where a difference in hue exists were not found. Furthermore, from an SEM photograph (150-fold magnification, the number of pixels is greater than or equal to 165 thousand pixels) of the section of the obtained electrostatic chuck heater 10, the depth of the recessed groove 17 was 10 μm, and the inclination angle α of the side wall surface 17a of the recessed groove 17 was 18°. The depth and the inclination angle α of the recessed groove 17 was obtained, by using the SEM photograph, in a method similar to the method for obtaining the depth D and the inclination angle β of the above-described recessed groove 67. In the SEM photograph, no gap was observed between the side wall surface 17a of the recessed groove 17 and the ceramic substrate (alumina substrate) 12. The inclination angle γ of the end surface 16a of the resistance heating element 16 along the longitudinal direction of the resistance heating element 16 was 5°. The inclination angle γ was obtained, by using the SEM photograph, in a method similar to the method for obtaining the inclination angle δ. The inclination angle of the end surface of the electrostatic electrode 14 was the same, 5°. No gap was observed between each of the end surfaces and the ceramic substrate 12, either.

### Example 2

The electrostatic chuck heater 10 was fabricated in a similar manner as that of example 1 except for that the number of times of processing of the conditions for laser processing of example 1 above was one. The depth and the inclination angle β of the recessed groove 67 of the resistance heating element precursor 66 were 10 μm and 18°, respectively. The inclination angle δ of the end surface 66a of the resistance heating element precursor 66 and the inclination angle of the end surface of the electrostatic electrode precursor 64 were 10°. When an SEM photograph of the section of the electrostatic chuck heater 10 was taken and observed in a similar manner as that of example 1, the depth of the recessed groove 17 was 5 μm, and the inclination angle α of the side wall surface 17a of the recessed groove 17 was 10°. No gap was observed between the side wall surface 67a of the recessed groove 67 and the ceramic substrate 12. The inclination angle γ of the end surface of the resistance heating element 16 along the longitudinal direction of the resistance heating element 16 was 5°. The inclination angle of the end surface of the electrostatic electrode 14 was the same, 5°. No gap was observed between each of the end surfaces and the ceramic substrate 12, either. Each inclination angle was obtained in a similar manner as that of example 1.

### Example 3

The electrostatic chuck heater 10 was fabricated in a similar manner as that of example 1 except for that the number of times of processing of the conditions for laser processing of example 1 above was three. The depth and the inclination angle β of the recessed groove 67 of the resistance heating element precursor 66 were 30 μm and 45°, respectively. The inclination angle δ of the end surface 66a of the resistance heating element precursor 66 and the inclination angle of the end surface of the electrostatic electrode precursor 64 were 10°. When an SEM photograph of the section of the electrostatic chuck heater 10 was taken and observed in a similar manner as that of example 1, the depth of the recessed groove 17 was 15 μm, and the inclination angle α of the side wall surface 17a of the recessed groove 17 was 27°. No gap was observed between the side wall surface 17a of the recessed groove 17 and the ceramic substrate 12. The inclination angle γ of the end surface of the resistance heating element 16 along the longitudinal direction of the resistance heating element 16 was 5°. The inclination angle of the end surface of the electrostatic electrode 14 was the same, 5°. No gap was observed between each of the end surfaces and the ceramic substrate 12, either. Each inclination angle was obtained in a similar manner as that of example 1.

Main results of examples 1 to 3 are listed in Table 1.

TABLE 1

| | No. of | Recessed groove 67 | | Recessed groove 17 | |
|---|---|---|---|---|---|
| | times of | (before firing) | | (after firing) | |
| | laser | Inclination | Depth | Inclination | Depth |
| | processing | angle β (°) | (μm) | angle α (°) | (μm) |
| Example 1 | 2 | 34 | 20 | 18 | 10 |
| Example 2 | 1 | 18 | 10 | 10 | 5 |
| Example 3 | 3 | 45 | 30 | 27 | 15 |

### Examples 4 and 5

As example 4, the electrostatic chuck heater 10 was fabricated in a similar manner as that of example 1 except for that the inclination angle δ of the end surface 66a was 18°. The inclination angle γ of the end surface 16a of the obtained resistance heating element 16 along the longitudinal direction of the resistance heating element 16 was 10°. As example 5, the electrostatic chuck heater 10 was fabricated in a similar manner as that of example 1 except for that the inclination angle δ of the end surface 66a was 45°. The inclination angle γ of the end surface 16a of the obtained resistance heating element 16 along the longitudinal direction of the resistance heating element 16 was 26°. No gap (abnormality in thermal uniformity due to the gap) was found near the end surface 16a of the resistance heating element 16 of example 4 or 5.

The present application claims priority from Japanese Patent Application No. 2020-030724, filed on Feb. 26, 2020, the entire contents of which are incorporated herein by reference.

What is claimed is:

1. A method of manufacturing a ceramic heater, the method comprising the steps of:
(a) forming, on a surface of a first ceramic fired layer or an unfired layer, a resistance heating element or a precursor of the resistance heating element in a predetermined pattern;
(b) forming a recessed groove along a longitudinal direction of the resistance heating element or the precursor of the resistance heating element by radiating laser light to the resistance heating element or the precursor of the resistance heating element;
(c) obtaining a layered body by disposing, on the surface of the first ceramic fired layer or the unfired layer, a second ceramic unfired layer such that the second ceramic unfired layer covers the resistance heating element or the precursor of the resistance heating element; and
(d) obtaining the ceramic heater in which the resistance heating element is embedded in a ceramic substrate by performing hot press firing on the layered body,
wherein, in the step (b), the recessed groove is formed such that a side wall surface of the recessed groove is inclined relative to the surface of the first ceramic fired layer or the unfired layer.

2. The method of manufacturing a ceramic heater according to claim 1,
wherein, in the step (b), the recessed groove is formed such that an inclination angle of the side wall surface of the recessed groove relative to the surface of the first ceramic fired layer or the unfired layer is smaller than or equal to 45°.

3. The method of manufacturing a ceramic heater according to claim 1,
wherein, in the step (b), the recessed groove is formed such that sectional areas of the resistance heating element or the precursor of the resistance heating element at a plurality of measurement points determined along the longitudinal direction of the resistance heating element or the precursor of the resistance heating element are predetermined target sectional areas, respectively.

4. The method of manufacturing a ceramic heater according to claim 1,
wherein, in the step (b), a depth of the recessed groove is smaller than or equal to half a thickness of the resistance heating element or the precursor of the resistance heating element.

5. The method of manufacturing a ceramic heater according to claim 1,
wherein, in the step (a), the resistance heating element or the precursor of the resistance heating element is formed such that an end surface of the resistance heating element or the precursor of the resistance heating element along the longitudinal direction of the resistance heating element or the precursor of the resistance heating element is inclined relative to the surface of the first ceramic fired layer or the unfired layer.

6. The method of manufacturing a ceramic heater according to claim 5,
wherein, in the step (a), the resistance heating element or the precursor of the resistance heating element is formed such that, relative to the surface of the first ceramic fired layer or the unfired layer, an inclination angle of the end surface of the resistance heating element or the precursor of the resistance heating element along the longitudinal direction of the resistance heating element or the precursor of the resistance heating element is smaller than or equal to 45°.

7. The method of manufacturing a ceramic heater according to claim 5,
wherein, in the step (b), the inclination angle of the side wall surface of the recessed groove is greater than the inclination angle of the end surface of the resistance heating element or the precursor of the resistance heating element along the longitudinal direction of the resistance heating element or the precursor of the resistance heating element.

8. A ceramic heater,
wherein, in the ceramic heater, a resistance heating element is embedded in a ceramic substrate, wherein the ceramic heater includes
a recessed groove provided, along a longitudinal direction of the resistance heating element, in a surface of the resistance heating element, and
a side wall surface of the recessed groove inclined relative to a surface of the ceramic substrate,
wherein no gap exists between the side wall surface of the recessed groove and the ceramic substrate.

9. The ceramic heater according to claim 8,
wherein an inclination angle of the side wall surface of the recessed groove relative to the surface of the ceramic substrate is smaller than or equal to 27°.

10. The ceramic heater according to claim 8,
wherein an opening edge of the recessed groove are chamfered.

11. The ceramic heater according to claim 8,
wherein a depth of the recessed groove is smaller than or equal to half a thickness of the resistance heating element.

12. The ceramic heater according to claim 8,
wherein an end surface of the resistance heating element along the longitudinal direction of the resistance heating element is inclined relative to the surface of the ceramic substrate, and
no gap exists between the end surface and the ceramic substrate.

13. The ceramic heater according to claim 12,
wherein an inclination angle of the end surface of the resistance heating element along the longitudinal direction of the resistance heating element relative to the surface of the ceramic substrate is smaller than or equal to 27°.

14. The ceramic heater according to claim 12,
wherein an inclination angle of the end surface of the resistance heating element along the longitudinal direction of the resistance heating element is smaller than the inclination angle of the side wall surface of the recessed groove.
